(19) United States
(12) Patent Application Publication
(10) Pub. No.: US 2015/0379701 A1
(43) Pub. Date: Dec. 31, 2015

(54) INSPECTION CAMERA UNIT, METHOD FOR INSPECTING INTERIORS, AND SENSOR UNIT

(71) Applicants: DNV GL SE, Hamburg (DE); DEUTSCHES ZENTRUM FÜR LUFT-UND RAUMFAHRT E.V., Köln (DE)

(72) Inventors: Anko BÖRNER, Berlin (DE); Sergey ZUEV, Berlin (DE); Denis GREISSBACH, Berlin (DE); Dirk BAUMBACH, Erfurt (DE); Maximillian BUDER, Neustrelitz (DE); Andre CHOINOWSKI, Berlin (DE); Marc WILKEN, Hamburg (DE); Christian CABOS, Hamburg (DE)

(21) Appl. No.: 14/765,566

(22) PCT Filed: Feb. 4, 2014
(86) PCT No.: PCT/EP2014/052173

§ 371 Date: Aug. 3, 2015

(30) Foreign Application Priority Data
Feb. 4, 2013 (DE) 10 2013 201 769.3
Nov. 6, 2013 (DE) 10 2013 222 570.9

(51) Int. Cl. G06T 7/00; H04N 7/18; H04N 9/04; H04N 5/33; G06K 9/62; G06K 9/52; G01N 21/88; H04N 13/02

(52) U.S. Cl. CPC G06T 7/001; G01N 21/8806; H04N 7/18; H04N 13/0239; G06T 7/0002; H04N 5/33; G06K 9/6201; G06T 7/0044; G06K 9/52; H04N 13/0246; H04N 9/04

(57) ABSTRACT

So as to provide an inspection camera unit comprising an inspection camera for taking preferably color inspection photos of interiors, in particular of ships, and a method for inspecting interiors, in particular of ships, by taking preferably color inspection photos using the inspection camera, to thereby increase the utility of the inspection photos and also make improved historical consideration possible, it is proposed for the inspection camera unit to comprise referencing means for referencing the inspection photos and for the inspection photos to be referenced by determining relative location data of the inspection camera and orientation data of the inspection camera during the capture of the inspection photos and assigning them to the inspection photos, the relative location data and the orientation data subsequently being classified into a coordinate system of the interiors.

### CROSS-REFERENCE TO RELATED APPLICATIONS

The invention relates to a measurement arrangement and to a measurement method, in particular for measuring closed spaces.

The inspection of industrial plants, buildings, and also ships is useful for example for early detection of damage and/or for providing operational safety. Sensor systems which capture the data required for this purpose may for example be camera systems having any desired spectral range, humidity sensors or gas sensors. However, in general the data generated by these sensor systems can only be expediently and usefully used if they are spatially referenced. This means that for each measurement signal a situation, in other words position and/or orientation, of the sensor system should also be known.

Situation detection using a GNSS (global navigation satellite system) provides spatial referencing of this type for measurement data in outdoor regions at a position precision of a few centimetres, for example when using a differential GPS (global positioning system), to a few metres. It is not possible to determine orientation using GNSS. However, in closed spaces, for example in interiors of buildings or vehicles, in particular ships, the functionality and precision of the GNSS may be impaired. In the outdoors, the quality of the position measurement by GNSS may be impaired in unfavourable conditions, for example by shadowing and multiple reflections.

For spatially referencing measurement data, it is possible for example to use terrestrial microwave transceiver units. Thus for example RFID (radiofrequency identification) systems, pseudolite systems or WLAN-based systems may be used for spatial referencing, but require corresponding technical fitting of the measurement environment in advance of the measurements. It is also possible to use inertial measurement systems. These systems measure angular speeds and accelerations, which can be processed by single or double integration to give orientation and position values. This concept leads to rapid accumulation of large errors, and this can only be circumvented by using large, expensive inertial measurement systems. In addition, compass-based systems may also be used. All of these systems can be used in interiors. Maps which have been created in advance (for example building blueprints, electrical field strength maps) are often used to support the measurement values.

It is common to all known methods for spatially referencing measurement data without GNSS that they require a priori information, for example from maps or from equipping the object to be measured with corresponding technical aids, and are expensive.

Further, there are approaches for photogrammetric localisation of measurement data. In this context, a number of spatially overlapping images are taken in an interior region to be analysed. One problem with this is that localisation by photogrammetric approaches is only real-time-capable under some circumstances, since generally the entire image block (from the first to the last image) has to be present so as retroactively to determine the trajectory of the measurement system and thus to ensure the spatial referencing of the measurement values.

The subsequently published DE102011084690.5 describes a camera comprising at least one optical system, at least one optical detector arranged in a focal plane of the optical system, and an evaluation unit, the camera comprising at least one light source and at least one diffractive optical element, the diffractive optical element being illuminable by means of the light source so as to generate various plane waves, which are each imaged on the optical detector as a point by the optical system and evaluated by the evaluation unit at least for geometric calibration, and to a method for geometrically calibrating a camera.

The technical problem arises of providing a measurement arrangement and a measurement method which simplify spatial referencing of measurement data and make temporally rapid spatial referencing possible, a priori knowledge, for example in the form of maps or additional infrastructure, not being required.

The technical problem is solved by the subjects having the features of claims 1 and 8. Further advantageous embodiments are provided in the dependent claims.

A basic idea of the invention is that a calibration arrangement comprises both a sensor system for generating measurement data and at least two situation detection systems for generating position and/or orientation data, the situation detection systems being situation detection systems which are unreferenced with respect to the environment. The measurement arrangement detects its own position and orientation in a relative coordinate system, the origin of which may for example be set by a user. The measurement data are stored referenced with respect to local position and/or orientation data of the situation detection systems which are detected in this relative coordinate system.

In the following, the following definitions apply. A situation describes a position and/or an orientation of an object at least in part. A position may for example be described by three translational parameters. For example, translational parameters may comprise an x-parameter, a y-parameter and a z-parameter in a Cartesian coordinate system. An orientation may for example be described by three rotational parameters. For example, rotational parameters may comprise an angle of rotation ω about an x-axis, an angle of rotation φ about a y-axis and an angle of rotation κ about a z-axis of the Cartesian coordinate system. A position can thus comprise up to six parameters.

A measurement arrangement is proposed, it also being possible to refer to the measurement arrangement as a measurement system. The measurement arrangement is used in particular for measuring closed spaces, in particular for measuring ship spaces, mines, buildings and tunnels. Alternatively or in addition, the measurement arrangement is used for measuring outdoor regions having disrupted or absent GNSS reception. In the context of the present invention, measurement means that measurement signals, the detection of which is triggered automatically or manually by a user, are generated and spatially referenced. In addition, measurement data may also be temporally referenced.

The measurement arrangement comprises at least one sensor system for generating measurement data. The sensor system may for example be a camera system for generating camera images, a moisture sensor or a gas sensor. Naturally, other sensor systems may also be used.

The measurement arrangement further comprises a first unreferenced situation detection system for detecting first position and/or orientation data and at least a second unreferenced situation detection system for detecting second position and/or orientation data.

Preferably, the first and the at least second position detection system operate by mutually independent measurement principles. This advantageously makes improved redundancy and an increase in precision possible in the detection of position and/or orientation information.

In this context, the term “unreferenced” means that the generated position and/or orientation data are determined exclusively relative to a system-internal coordinate system of the situation detection systems or relative to a shared coordinate system of the situation detection systems, the shared coordinate system being fixed in location and in rotation with respect to the measurement arrangement. Thus, for example, the first position and/or orientation data may be determined relative to a system-internal coordinate system of the first situation detection system. Accordingly, the second position and/or orientation data may also be determined in a system-internal coordinate system of the second situation detection system.

Further, the term “unreferenced” may mean that no unambiguous detection of the position and/or orientation, for example in a global coordinate system, is possible using the unreferenced situation detection system. This means that at least one parameter required for unambiguous and complete description of the situation, in other words the position and/or orientation, cannot be detected or determined using the unreferenced situation detection system.

For example, an unambiguous spatial referencing in a superordinate, for example global, coordinate system may require the detection or determination of three position and three orientation parameters in this superordinate coordinate system. If this cannot be fully provided, the situation can only be determined in a system-internal coordinate system, even if some individual parameters of the situation in the superordinate coordinate system can be detected. For example, inclination sensors can detect two orientation angles and magnetic sensors can detect one orientation angle with spatial reference to a global coordinate system.

Unreferenced also means that no spatial reference to a previously known spatial map is known.

In this context, a position may for example be determined on the basis of a Cartesian coordinate system having three linearly independent axes. The situation detection system thus makes it possible to detect a movement with three translational degrees of freedom. Alternatively or in addition, orientation data may be determined as an angle of rotation about the three axes of the Cartesian coordinate system, for example using the yaw-pitch-roll angle convention. In this way, it is possible to determine an angular position using three mutually independent rotational degrees of freedom.

As is explained in greater detail in the following, an origin of the coordinate system may be set for example when the situation detection system is switched on, in other words at the beginning of a power supply, or at the beginning of a measurement process or when an initiation signal is generated. This means that at one of the aforementioned moments current position and/or orientation coordinates are reset or zeroed, all detected position and/or orientation data subsequently being determined relative to the set origin of the coordinate system.

The measurement arrangement further comprises at least one storage device.

The measurement data and the, in particular temporally corresponding, position and/or orientation information coded by the first and/or second position and/or orientation data can be stored referenced to one another, in other words with a previously known allocation to one another, in the storage device.

This means that both the measurement data and the corresponding position and/or orientation information are stored. The position and/or orientation information may be provided in the form of unprocessed output signals (raw signals) of the unreferenced situation detection systems. The position and/or orientation information may also be provided by previously processed output signals of the unreferenced situation detection systems, the processed output signals in turn coding or representing a position and/or orientation exclusively referenced to the system-internal coordinate system(s) or to a shared coordinate system fixed with respect to the measurement arrangement.

For example, the measurement data and the temporally corresponding first and/or second unprocessed position and/or orientation data may be stored referenced to one another.

It is thus possible to assign measurement data to a position and/or orientation and to query this assignment at a later time. However, an assignment is only possible with respect to positions in the unreferenced system-internal coordinate systems of the situation detection systems or with respect to positions in a shared coordinate system fixed with respect to the measurement arrangement.

The measurement arrangement described may be formed to be portable, in particular wearable by a human user. However, it is also possible to form the measurement arrangement described to be mountable on a positioning device, for example on a vehicle, in particular on a robot.

The proposed measurement arrangement advantageously makes spatial referencing of measurement data possible even in closed spaces, in particular in interiors of for example industrial plants, buildings or ships. Since the spatial referencing takes place independently of a global coordinate system, for example a coordinate system of a GNSS, and also independently of further additional arrangements, such as transmitters installed in the rooms, this advantageously results in a measurement arrangement which is as simple and cost-effective as possible.

The use of at least two situation detection systems advantageously increases the availability of position and/or orientation information and the precision of the position and/or orientation information. For example, if situation detection by one of the at least two situation detection systems is not possible, for example because of external conditions or if the situation detection system fails, position and/or orientation data or information from the remaining situation detection system are still available.

The data stored by the measurement arrangement make navigation in previously measured spaces possible at a later time. The data may also be used for creating or adjusting plant/building/ship models.

In a further embodiment, the measurement arrangement comprises a computation device, the computation device being able to combine the first and second position and/or orientation data into resultant position and/or orientation data. The resultant position and/or orientation data may subsequently for example form the aforementioned position and/or orientation information.

In this context, for example position and/or orientation data of a situation detection system may be converted into the system-internal coordinate system of the further situation detection system. For this purpose, it is necessary for a mapping instruction for such a conversion to be known in advance. In other words, this means that the system-internal coordinate systems of the situation detection systems are indexed to one another.

It is also possible for both the first and the second position and/or orientation data to be converted into a shared coordinate system of the measurement arrangement. In this context, the coordinate system of the measurement arrangement refers to a coordinate system fixed in location and in rotation with respect to the measurement arrangement. This in turn means that, when the measurement arrangement moves in translation and/or in rotation, the shared coordinate system of the measurement arrangement also moves in translation and/or in rotation in an equivalent manner. As stated above, for this purpose it is necessary for the system-internal coordinate systems to be indexed to the shared coordinate system.

This advantageously makes it possible to save storage space, since measurement data now only have to be stored referenced to the resultant position and/or orientation data.

In a further embodiment, the first unreferenced situation detection system is formed as an optical situation detection system and the at least second unreferenced situation detection system is formed as an inertial situation detection system.

In the optical situation detection system, a change in position and/or change in orientation is detected optically, for example in an image-based manner. In an inertial situation detection system, one or more inertial sensors are used for detecting acceleration and/or rates of rotation. If for example accelerations are detected, a current position can be determined on the basis of a previously covered distance, the covered distance resulting from for example double integration of the detected accelerations. If a rate of rotation is detected, a current angle can be determined for example by single integration of the rate of rotation.

In this context, the use of an optical and an inertial situation detection system advantageously implements situation detection on the basis of two mutually independent physical measurement principles. Further, this advantageously means that according to the invention inertial situation detection systems operate robustly and thus provide high availability of the position and/or orientation data. Optical situation detection systems generally make possible high-precision determination of a situation and/or orientation. The use of the proposed situation detection systems thus advantageously results in high availability and high precision in the determination of position and/or orientation information.

In a further embodiment, the optical situation detection system is formed as a stereo camera system. In this context, a stereo camera system advantageously makes possible simple, image-based determination of a spatial position and/or spatial orientation of objects or persons in the detection region of the stereo camera system. For this purpose, it may be necessary to carry out the method for image-based feature or object detection by which corresponding persons or objects, each imaged by a camera of the stereo camera system, are detected. Naturally, further image processing methods may also be used which improve determination of the spatial position and/or orientation, for example noise suppression methods, segmentation methods, and further image processing methods. In addition, stereo images or individual images taken in temporal succession may be used to carry out three-dimensional reconstruction, for example in a structure-from-motion method.

In particular, at least one panchromatic camera or a colour camera, in particular an RGB-based colour camera, or an infrared camera may be used in the stereo camera system. Alternatively or in addition, it is possible for the cameras used in the stereo camera system to have different geometric, radiometric and/or spectral properties. For example, the spatial resolution and/or spectral resolution of the cameras used may differ from one another. This advantageously means that one of the cameras can be used as a measurement system, as described in greater detail in the following, for example if a high-spatial-resolution RGB camera and a low-spatial-resolution panchromatic camera are used.

In a further embodiment, the measurement arrangement comprises a calibration device for calibrating the stereo camera system.

In this context, geometric calibration of cameras is a basic prerequisite for the use thereof as a situation detection system. The calibration may also be referred to as determination of parameters of an internal orientation of the camera. The aim is to determine a viewing direction (line of sight) in the camera coordinate system for each image point of an image generated by a camera of the stereo camera system.

In this context, the calibration device may be formed for example in such a way that a camera of the stereo camera system or all of the cameras of the stereo camera system comprise an optical system, at least one optical detector which is arranged in a focal plane of the optical system, and an evaluation device. Further, the camera may comprise at least one light source and at least one diffractive optical element, the diffractive optical element being illuminable by the light source so as to generate various plane waves, which are each imaged on the optical detector as a point by the optical system and are evaluated by the evaluation unit at least for geometric calibration.

A system of this type is described in the subsequently published DE102011084690.5.

In this context, the diffractive optical element may be illuminable by way of the optical system by means of the light source. Further, the light source may be formed and orientated in such a way that it emits spherical wavefronts, which impinge on the diffractive optical element after being converted into plane waves by the optical system.

The optical detector may be formed as a matrix sensor. The at least one diffractive optical element may be integrated into the optical system. Alternatively, the diffractive optical element may be arranged on the optical system. As a further alternative, the diffractive optical element may be arranged on an aperture of the optical system. It is also possible for the camera to comprise a plurality of light sources which have different emission directions. Further, the light source may be arranged in the focal plane. It is also possible for the light source to comprise an optical phase, the aperture of which forms the light output of the light source.

Diffractive optical elements are known in a wide range of embodiments, passive and active diffractive optical elements being known, the latter also being known as SLMs (spatial light modulators). SLMs may for example be formed as an adjustable micro-mirror array (reflective SLM) or as a transmissive or reflective liquid crystal display (LCD). These may be actively controlled, in such a way that the diffraction structures thereof can be varied over time. By contrast, passive diffractive optical elements have a fixed diffraction pattern, and may be formed reflectively or transmissively.

In relation to further embodiments of the camera comprising a calibration device, reference is hereby made to the embodiment disclosed in DE102011084690.5.

This advantageously means that calibration of one or all of the cameras of the stereo camera system is also possible during operation, and lasting high-precision determination of the position and/or orientation is thus also possible.

In a further embodiment, the measurement system is simultaneously formed as an unreferenced situation detection system. For example, the measurement system may be formed as a camera or camera system which is simultaneously part of the stereo camera system. In this context, the measurement system generates image data as measurement data, the generated image data simultaneously being used to provide situation information.

Naturally, it is also conceivable to use other measurement systems of which the output signals can be used to provide position and/or orientation information.

In a further embodiment, the measurement arrangement additionally comprises at least one further situation detection system, for example a third situation detection system.

The further situation detection system may for example comprise or be formed as a GNSS sensor. A GNSS sensor makes situation detection possible by receiving signals from navigation satellites and pseudolites.

Alternatively, the further situation detection system may be formed as a laser scanner or comprise such a laser scanner. In this context, the laser scanner may be a one-dimensional, two-dimensional or three-dimensional laser scanner, which accordingly makes possible one-dimensional, two-dimensional or three-dimensional imaging of an environment of the measurement arrangement. By carrying out the data processing accordingly, in a manner corresponding to the image processing, object detection in the output signals generated by the laser scanner can be provided. Depending on the detected objects, a movement, in other words a change in position and/or orientation of the measurement arrangement between two points in time, can thus be determined. Algorithms exist for this purpose, for example the ICP (iterative closest point) algorithm.

Alternatively, the further situation detection system may be formed as a magnetometer. In this context, a magnetometer refers to a device for detecting a magnetic flux density. Using a magnetometer, it is possible to detect for example the earth's magnetic field or a superposition of the earth's magnetic field and a further magnetic field, generated for example by an electrical generator, in the closed spaces. Further, the magnetometer may also be used as a situation detection system.

As a further alternative, an inclination sensor may be used as a further situation detection system. In this context, an inclination sensor may for example detect changes in an angle of inclination. These changes in the angle of inclination may in turn be used as a basis for determining an orientation of the measurement arrangement. For example, the inclination sensor may also detect a current angle difference from the direction of acceleration due to gravity. The inclination sensor may thus operate in the manner of a spirit level.

In this context, the output signals of the aforementioned situation detection systems may be stored separately or be combined with the first and second situation and/or orientation data as explained above.

A measurement method, in particular for measuring closed spaces and/or outdoor regions having disrupted or absent GNSS reception, is further proposed, in which a sensor system generates measurement data. A first unreferenced situation detection system further generates first position and/or orientation data and at least a second unreferenced situation detection system generates second position and/or orientation data. Further, the measurement data and the, in particular temporally corresponding, position and/or orientation information coded by the first and/or second position and/or orientation data are stored referenced to one another.

The proposed method may advantageously be used for inspecting closed spaces of natural and unnatural origin, for example caves and shafts, using reference-free situation detection systems.

For the proposed method, it may be necessary to index the used situation detection systems to one another. For this purpose, temporal, rotational and/or translational relationships between the situation detection systems and if appropriate the measurement system have to be determined, so as to be able to combine the situation data and determine them in a reference coordinate system. Methods are known for this referencing of the situation sensors.

The proposed method thus makes it possible to inspect buildings in the context of facility management, for example in relation to noise-protection measures. Further, it is made possible to inspect buildings in the context of safety-related tasks, for example for uses by the police and fire brigade. It is further possible to inspect industrial plants, for example of ships or tanks.

In a further embodiment, the first and second positioning and/or orientation data are combined into resultant position and/or orientation data, exclusively the position and/or orientation information coded by the combined or resultant position and/or orientation data being stored. The combined position and/or orientation data may form the position and/or orientation information or the position and/or orientation information may be determined as a function of the combined position and/or orientation data.

This advantageously results in a precision improved as explained above of the position and/or orientation information and in a reduced storage space requirement.

In a further embodiment, an origin of a system-internal coordinate system of the first unreferenced situation detection system and an origin of a system-internal coordinate system of the second unreferenced situation detection system or an origin of a shared coordinate system can be initialised at the beginning of an operation of a measurement arrangement or at the beginning of a measurement or at the time of the generation of an initialisation signal. In this context, initialised means that current position and/or orientation information or position and/or orientation data starting from the time of initialisation are used as reference or origin coordinates. Thus, the current position and/or orientation information or the position and/or orientation data are reset. Starting from this time and until a further initialisation, position and/or orientation information are now determined relative to this origin.

An initialisation signal may for example be generated by actuating a corresponding actuation device, for example a key or switch. Thus, when the measurement arrangement is in a position and/or orientation desired by a user, he can initialise the system-internal coordinate system. In this case, all previously generated position and/or orientation information or position and/or orientation data can be converted to the newly initialised origin. It is thus advantageously possible not to lose previously generated information for spatial referencing. Thus, a user can for example carry out a complete measurement and, after the measurement, initialise the system-internal coordinate systems in a position and/or orientation of the measurement arrangement desired by said user.

For example, in this way a reference to a global coordinate system can be established. Thus, the measurement arrangement can be brought into a position and/or orientation which is known in relation to a desired global coordinate system, for example a coordinate system of a GNSS. If the system-internal coordinate systems of the situation detection systems are initialised in this position and/or orientation, indexing between the previously generated or as yet ungenerated position and/or orientation information and the global coordinate system can be determined. For example, it is possible for a user to measure closed spaces in the manner proposed according to the invention and, after the end of the measurement, to move out of the closed spaces into an open space, in which a position and/or orientation can be determined at a sufficient precision for example using a GNSS sensor. Further, a current position and/or orientation of the measurement arrangement can subsequently be determined in a coordinate system of the GNSS, for example using a GNSS sensor. Further, as stated above, the system-internal coordinate systems of the situation detection systems can be initialised and the stored position and/or orientation information can be converted to the coordinate system of the GNSS.

It is also possible, for example in an image-based manner, to detect a structure or an object of which the position and/or orientation is known in a global coordinate system. Further, a position and/or orientation of the detected structure or of the detected object can be determined in the system-internal coordinate system of the situation detection systems. Finally, the previously determined position and/or orientation information or the as yet undetermined position and/or orientation information can be converted to the global coordinate system.

In this case, the unreferenced system-internal coordinate systems of the situation detection systems can thus be initialised to the position and/or orientation of the object or structure.

If a stereo camera is used as a situation detection system, spatial referencing of a 2D/3D environment model, generated as a function of the image data of the stereo camera system, is also possible.

A trajectory of the measurement arrangement can also be determined from the determined and stored position and/or orientation information. It is thus possible to represent a trajectory in a 2D/3D model at a later time.

The present invention further relates to an inspection camera unit comprising an inspection camera for taking preferably colour inspection photos of interiors, in particular of ships.

The invention equally relates to a method for inspecting interiors, in particular of ships, by taking preferably colour inspection photos using an inspection camera unit.

Finally, the invention relates to a sensor unit comprising a sensor means for measurement detection of at least one property of interiors, in particular of ships.

In the inspection of interiors, for example of industrial plants, in particular of ships, which is often prescribed by the authorities, photos are useful as visual information carriers for documentation. For example, using inspection photos, the structural state of a ship at a particular time can be documented. This is generally common when carrying out a conventional method or using a conventional inspection camera unit, in particular in connection with ships. However, in this context the inspection photos are managed unsystematically like pictures in a shoebox, without a reference for the respective inspection photo as regards the location and orientation in the hull being provided. At best, manual records relating to the situation of inspection photos are noted unsystematically by the inspector who took the inspection photos, by memory after the end of an inspection process.

The use of the inspection photos is therefore disadvantageously restricted, since both the ability to relocate damage documented by an inspection photo in the hull and the historical evaluation of the development of structural damage over time by comparing inspection photos taken at different times are disadvantageously not possible systematically or only possible with increased effort.

For the described reasons, it is also not possible or only possible with increased effort to classify inspection photos into an existing model, for example of the hull.

There is therefore a need for an inspection camera unit of the aforementioned type and for a method for inspecting interiors of the type mentioned at the outset which each increase the utility of the inspection photos and for example also make improved historical consideration possible. There is likewise a need for a sensor unit of the type mentioned at the outset.

It is therefore an object of the present invention to provide an inspection camera unit of the type mentioned at the outset, an inspection method of the type mentioned at the outset and a sensor unit which are improved in the stated respect.

According to the invention, this object is achieved by an inspection camera unit comprising an inspection camera for taking preferably colour inspection photos of interiors, in particular of ships, which comprises referencing means for referencing the inspection photos. Within the meaning of the present document, the term “referencing” means in particular detecting position and/or orientation data. Because according to the invention the inspection camera unit is capable of detecting its position and/or orientation, this information can automatically be appended to each inspection photo taken using the inspection camera. This makes systematic evaluation of the inspection photos possible including in the case of historical consideration.

If the location data and orientation data detected by the referencing means are referenced against an existing external coordinate system of the interior for inspection, for example of the ship, in other words if registering is provided, in other words determination of the coordinate transformation between the coordinate system used for the positioning and the ship coordinate system using at least one control point, the inspection photos taken during the inspection using the inspection camera unit according to the invention can advantageously be assigned to the external ship coordinate system. Registering within the meaning of the invention can equally be carried out by manually assigning points of the ship coordinate system to points of the coordinate system used for positioning. For example, an operator manually selects at least one control point in an inspection photo and respectively assigns it to a location in the ship coordinate system.

In a preferred embodiment of the inspection camera unit according to the invention, the referencing means comprise a stereo camera comprising a first referencing camera and a second referencing camera for determining relative location data of the inspection camera and orientation data of the inspection camera which can be assigned to the inspection photos. In this context, the first and second referencing cameras are arranged in a fixed spatial arrangement with respect to the inspection camera within the inspection camera unit. By way of the reference images of the two referencing cameras of the stereo camera, which are taken parallel, the location and orientation of the stereo camera and thus the inspection camera with respect to the interior can be determined by image processing using trigonometric calculations if there is a known fixed distance between the first and second referencing cameras.

To reduce the volume of data, in the context of the invention the first referencing camera and/or the second referencing camera may be configured as a black-and-white camera. In many applications, for the purposes of referencing the inspection photos it will be sufficient merely to record contrasts and not colour information. The considerable data reduction which advantageously results from this makes it possible to use image processing during the referencing using the reference images taken by the referencing cameras. Advantageously, according to the invention referencing is thus also possible in real time. This advantageously also makes it possible for example to record a trajectory followed by the inspection camera unit according to the invention during an inspection process in the interior, in other words in particular in the hull.

In a further preferred embodiment of the invention, the stereo camera is configured to be infrared-sensitive, and comprises an infrared source, the infrared source preferably being configured to be capable of pulsed operation. Since the inspection often takes place in poorly lit or completely dark interiors, the use of infrared images in the stereo camera is advantageous. If the inspection photos are taken in the visible spectrum, in particular in colour, the embodiment according to the invention of the stereo camera as an infrared-sensitive camera additionally ensures that the infrared source does not affect the inspection photos. Further, an infrared source advantageously requires less energy than for example a light source in the visible spectrum. Pulsed operation of the infrared source advantageously reduces the energy requirement of the infrared source. This is advantageous with a view to operating the inspection camera unit according to the invention as a portable device, for example as a helmet camera unit, without an external energy supply. In a further advantageous embodiment of the inspection camera unit according to the invention, the stereo camera comprises an image processing unit for referencing using an image comparison of a first reference image taken using the first referencing camera and a second reference image taken parallel using the second referencing camera. This configuration of the invention advantageously makes it possible for the inspection camera unit to determine location data and orientation data assigned to the inspection photos, in particular in real time. Advantageously, in this way it is possible merely to record one parameter set to characterise the location data, typically a coordinate triplet, and the orientation data, typically an angle triplet. The storage requirement is advantageously much lower than for storing complete reference images.

It is particularly favourable if in the context of the invention the image comparison comprises selecting at least one evaluation pattern in the first reference image, locating the evaluation pattern in the second reference image, and determining the position of the evaluation pattern within the first reference image and within the second reference image. Taking into account the known distance of the first referencing camera from the second referencing camera, the location and orientation of the stereo camera, and for a known, fixed arrangement of the inspection camera relative to the stereo camera the location and orientation of the inspection camera, can be determined using trigonometric calculations given knowledge of the positions of the evaluation pattern within the two reference images.

The referencing is configured particularly reliably if in an embodiment of the invention the evaluation pattern comprises an image region having a maximum contrast.

In a development of the inspection camera unit according to the invention, it comprises an acceleration sensor and/or an inclination sensor. Because an acceleration sensor can be provided according to the invention, the location determination and/or orientation determination are advantageously configured even more reliably, since there is an additional measurement value available which makes referencing of the inspection photos possible. If for example the referencing images cannot be evaluated, for example because they are blurred or because there is an obstacle in the beam path, it can be determined, from the last location and orientation value determined by the stereo camera, by way of the evaluation of the acceleration sensor and/or the inclination sensor, in what current position and what current orientation the inspection camera is located. This is advantageous in particular to determine a gap-free trajectory followed by the inspection camera unit during an inspection process in the interior for inspection, for example in the hull. However, even in cases where the reference images can be used in an unrestricted manner for referencing, data from an additional acceleration sensor and/or an additional inclination sensor are advantageous, since the search field for locating the current position of the evaluation pattern can be restricted in a targeted manner given knowledge of the likely position of the evaluation pattern in the reference image. As a result, the computation time can advantageously be reduced.

In a further advantageous embodiment of the inspection camera unit according to the invention, the referencing means are configured to evaluate data relating to an opening angle of the inspection camera. The additional knowledge of the opening angle of the inspection camera, in connection with the knowledge of the registering with respect to a coordinate system of the interior to be analysed, in particular the ship to be analysed, makes it possible to establish whether two given inspection photos show the same portion of the given interior. In the context of the invention, the assignment to a ship coordinate model may be useful for determining an intersection of the detection angle of the inspection camera with walls of the ship interior. This is decisive for a historical analysis, if for example it is to be established by comparing inspection photos taken at different times whether structural damage has increased or otherwise changed. Generally, in this way it is possible in the context of the invention to observe the development of findings over time, the term finding within this meaning also being able to comprise the state of a coating or the presence at a location of sludge or other deposits.

In another advantageous embodiment of the invention, the first referencing camera or the second referencing camera is the inspection camera. In this way, the complexity of the inspection camera unit according to the invention can advantageously be reduced. Thus, according to the invention, aside from the inspection camera which is present in any case for taking the inspection photos, merely one additional referencing camera is provided, an image comparison being made between the referencing image of the referencing camera and the inspection photo. If the inspection camera is a colour camera, the image comparison may be made after converting the inspection photo into a black-and-white photo.

In the context of the invention, it is advantageous if visual position display means, preferably comprising a laser light source, are provided for displaying an object region which is detectable from an inspection photo on the basis of the location and orientation of the inspection camera. For example, crosshairs can be projected onto the object region using laser light, and display the centre of an inspection photo when it is taken. This can be highly advantageous if the inspection camera unit according to the invention is for example worn by the inspector as a helmet camera and distinguishes the viewing angle of the inspector from the “viewing angle” of the inspection camera.

To promote problem-free referencing in real time, in an embodiment of the invention it is advantageous for the image comparison merely to be based on a sub-region, in particular a substantially line-like region, of the two reference images. Specifically, an evaluation pattern selected in the first reference image can be looked for on a line in the second reference image if the knowledge of the geometrical arrangement of the two referencing cameras of the stereo camera or data from an acceleration sensor and/or data from an inclination sensor are taken into account.

The inspection camera unit according to the invention makes it possible to store a trajectory, if a storage unit is provided, so as to store a temporal sequence of inspection photos and a temporal sequence of relative location data of the inspection camera and/or orientation data of the inspection camera.

In one embodiment of the invention, the location determination is completely decoupled from the taking of the inspection photos if the inspection camera is arranged between the first referencing camera and the second referencing camera. In this embodiment, the inspection camera is thus in particular configured separately from the first and second referencing cameras.

The object of the invention is achieved as regards the method by a method for inspecting interiors, in particular of ships, by taking preferably colour inspection photos using an inspection camera, in which the inspection photos are referenced by determining relative location data of the inspection camera and orientation data of the inspection camera during the capture and assigning them to the inspection photos, the inspection camera preferably being configured in accordance with any of claims 11 to 24.

In an advantageous embodiment of the method according to the invention, it includes a method for measuring structures in the interiors using the inspection photos, comprising:

selecting two inspection photo image points in an inspection photo,

subsequently determining reference image points corresponding to the selected inspection photo image points in the first reference image and in the second reference image,

and calculating the Euclidean distance between them.

As regards the sensor unit, the object of the invention is achieved by a sensor unit comprising sensor means for measurement detection of at least one property of interiors, in particular of ships, which, for the purpose of determining a situation of the sensor means characterised by relative location data and orientation data, is provided with situation indicator means for cooperating with the referencing means of an inspection camera unit according to any of claims 1 to 14.

For example, the sensor unit may comprise an ultrasound thickness measurement sensor as a sensor means, for ultrasound-based measurement of the thickness for example of a steel plate of a ship interior. Because according to the invention the sensor unit is provided with situation indicator means, it is possible in cooperation with an inspection camera unit as described above to determine the situation of the sensor means, in other words for example the situation of the ultrasound thickness measurement sensor. In this way, it can advantageously be established at what location and in what orientation for example the ultrasound thickness measurement sensor was located at the time of taking the measurement value. For this purpose, it must be arranged in the field of vision of the referencing means of the inspection camera unit during the measurement detection of the thickness.

In a preferred embodiment of the sensor unit according to the invention, the situation indicator means comprise regions, in particular point-like regions, which are arranged spaced apart on a sensor axis and which bring about an optical contrast. In the context of the invention, these regions may advantageously be used as an evaluation pattern having a maximum contrast during the above-described image comparison of the images of two referencing cameras. In a further favourable embodiment of the invention, the situation indicator means may be switched off and be able to be switched on.

In particular, the situation indicator means may comprise at least one point-like light source. For example, the situation indicator may be formed from two LEDs which are arranged spaced apart and which, when the storage of a measurement signal, for example an ultrasound thickness measurement, is triggered, are briefly switched on so as to be detectable by the referencing cameras as an evaluation pattern having maximum contrast.

### BRIEF DESCRIPTION OF THE DRAWINGS

The invention is described in greater detail by way of an embodiment with reference to drawings, in which, in detail:

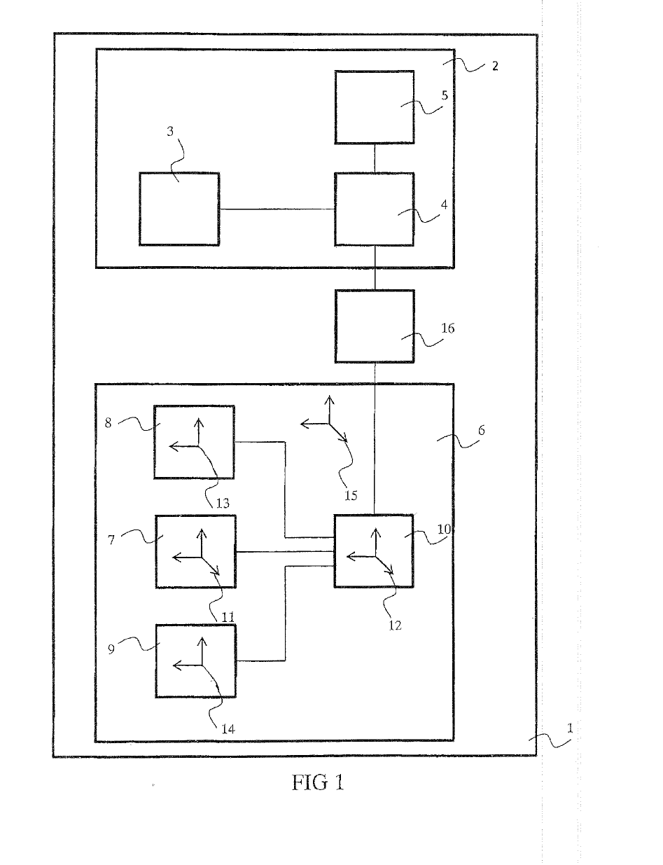

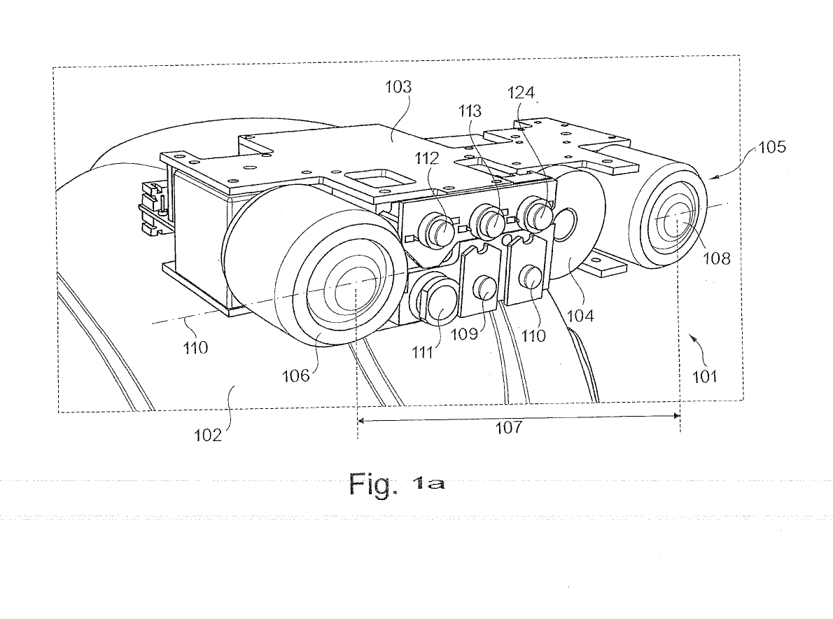

a. FIG. 1 is a schematic block diagram of a measurement arrangement;

b. FIG. 1a is a perspective schematic view of an embodiment of the inspection camera unit according to the invention;

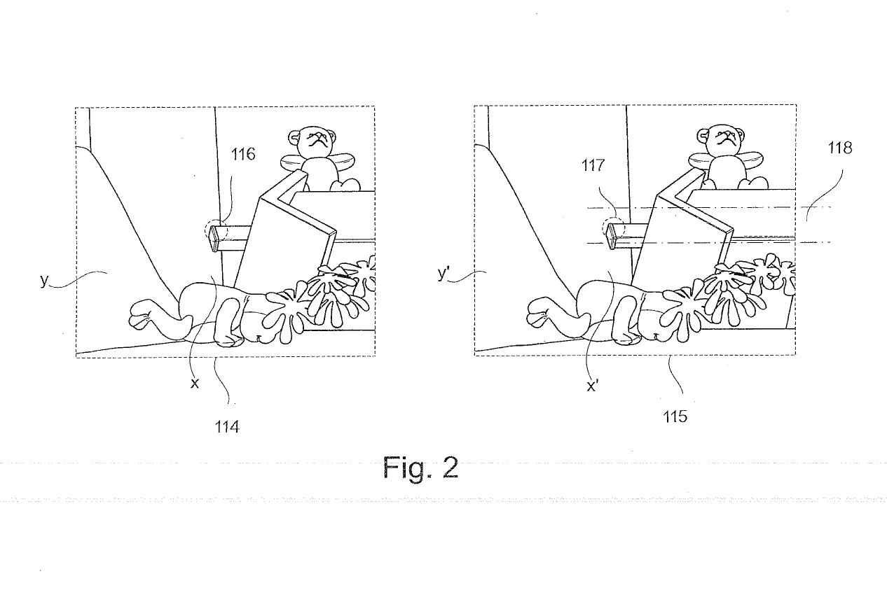

c. FIG. 2 is an example illustration of an embodiment of the image processing method used by the inspection camera unit according to FIG. 1a;

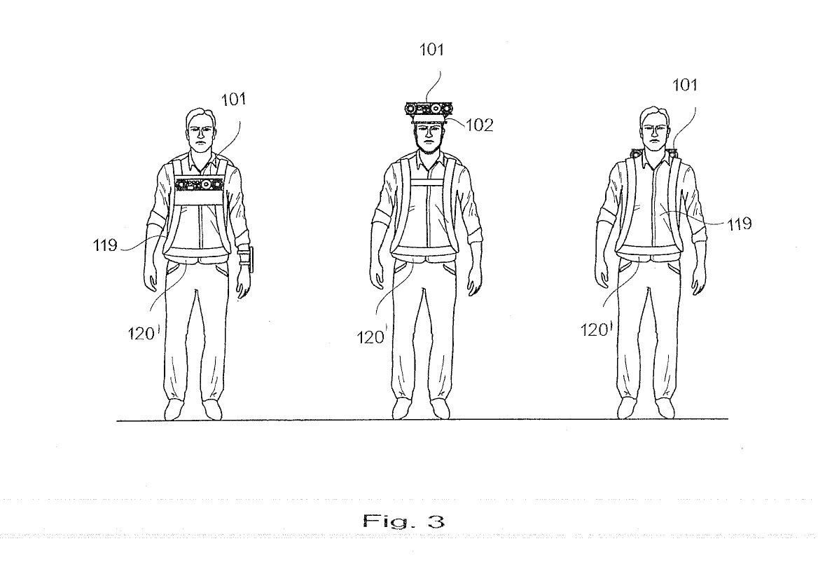

d. FIG. 3 is a schematic drawing of the illustration according to the invention of possible configurations of an inspection camera unit;

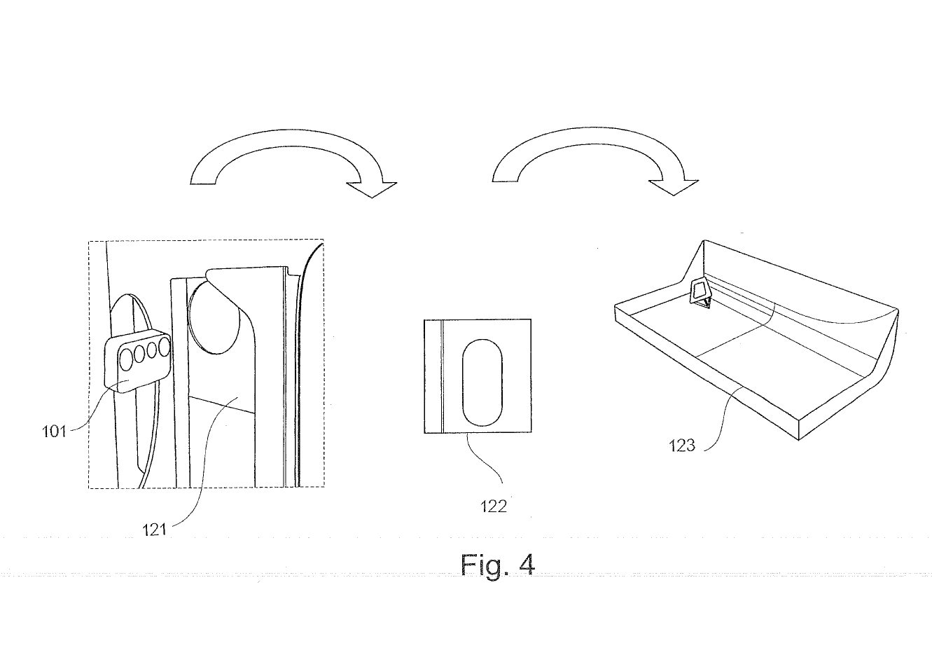

e. FIG. 4 is an example illustration of an embodiment of the method according to the invention;

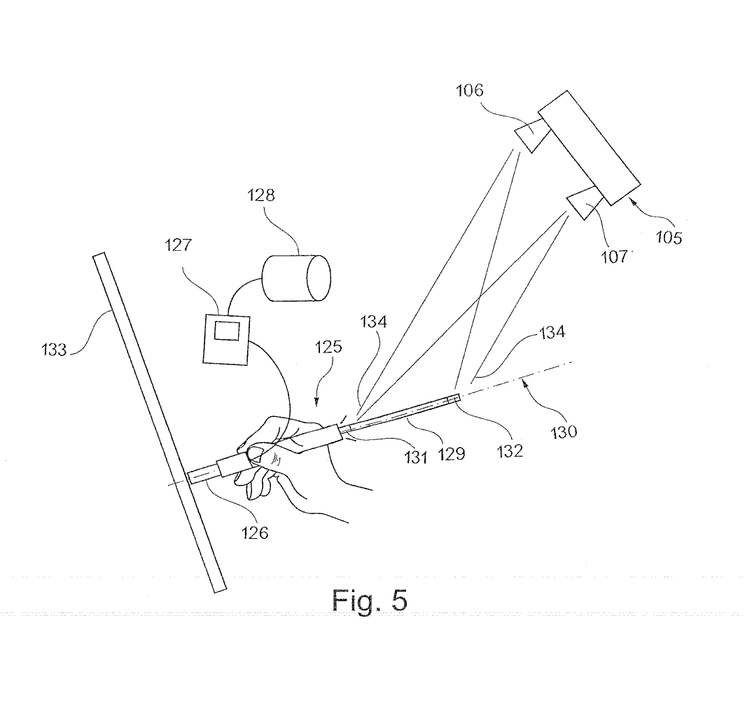

f. FIG. 5 is a schematic illustration of carrying out a thickness measurement using a sensor unit according to the invention in cooperation with an inspection camera unit according to the invention.

### DETAILED DESCRIPTION OF THE PREFERRED EMBODIMENTS

FIG. 1 is a schematic block diagram of a measurement arrangement 1 according to the invention. The measurement arrangement 1 comprises a sensor system 2 for generating measurement data. The sensor system 2 in this case comprises a sensor 3, for example a humidity sensor. The sensor system 2 further comprises a control and evaluation device 4, which can pre-process output signals from the sensor 3 and controls the operation of the sensor 3. It is further shown that the sensor system 2 comprises an actuation device 5 for activating the sensor system 2 or the measurement arrangement 1, which may for example be in the form of a switch.

The measurement arrangement 1 further comprises a combined situation detection system 6. The combined situation detection system 6 comprises an inertial sensor 7 as a first unreferenced situation detection system. Further, the combined situation detection system 6 comprises a stereo camera system, comprising a first camera 8 and a second camera 9, as a second unreferenced situation detection system. The first unreferenced situation detection system detects first position and orientation data with respect to a system-internal three-dimensional coordinate system 11. Correspondingly, the second unreferenced situation detection system detects second position and orientation data with respect to a system-internal three-dimensional coordinate system 12. In this context, the first camera 8 and the second camera 9 each detect image data in a two-dimensional camera-internal coordinate system 13, 14, the image data in these coordinate systems 13, 14 subsequently being converted by a further control and evaluation device 10 into the system-internal three-dimensional coordinate system 12. In this way, first position and/or orientation data from the inertial sensor 7 and image data from the cameras 8, 9 of the stereo camera system are passed to the further control and evaluation device 10, which calculates position and/or orientation information from the output signals, the first position and/or orientation data coded in the output signals of the inertial sensor 7 being combined with the position and/or orientation data coded in the image data of the cameras 8, 9. The calculated position and/or orientation information may for example be referenced to a coordinate system 15 fixed with respect to the measurement arrangement. In this context, the evaluation and computation device 10 may also carry out image processing methods. Further, the data determined by the first control and evaluation device 4 and those determined by the further control and evaluation device 10 are stored referenced to one another in a storage device 16. In this way, pre-processed measurement data are stored spatially referenced to a shared coordinate system, namely the coordinate system 15 fixed with respect to the measurement arrangement, of the inertial sensor 7 and the stereo camera system. In this context, the coordinate system 15 fixed with respect to the measurement arrangement is fixed in situation and in rotation with respect to the measurement arrangement 1.

The sensor system 2 and the elements of the combined situation detection system 6 are likewise arranged fixed in location and in rotation with respect to one another on or in the measurement arrangement 1. In particular, the cameras 8, 9 and the initial sensor 7 are also arranged fixed in location and in rotation with respect to one another. This means that registering between the individual output data does not change during operation.

The sensor system 2 and the elements of the combined situation detection system 6 may also be coupled mechanically loosely, for example if the requirements on the precision of the spatial referencing permit this. Mechanically loosely may for example mean that the mechanical coupling is formed in such a way that a position of the sensor system 2 is always within a spherical volume of a predetermined radius, a centre point of the spherical volume being known as referenced to the position and/or orientation information. This makes possible for example humidity measurement by hand directly on the side of a ship.

In this context, the further control and evaluation device 10 may determine in real time a situation in three translational and three rotational degrees of freedom with respect to the coordinate system 115 fixed with respect to the measurement arrangement. In addition, the further control and evaluation device 10 may generate a 3D model from the output signals of the cameras 8, 9. Information from the 3D model may likewise be stored spatially referenced in the storage device 16.

FIG. 1a shows an inspection camera unit 101 which is fastened on a work helmet 102. The precise nature of the fastening of the inspection camera unit 101 on the work helmet 102 cannot be seen from the drawing of FIG. 1a. It may be fastened in any desired manner familiar to the person skilled in the art.

The inspection camera unit 1a comprises a housing frame 103, to which various individual components, described in greater detail in the following, are attached in fixed positions with respect to one another.

On the one hand, an inspection camera 104 is fastened to the housing frame 103. The inspection camera 104 is configured as a digital colour camera of a suitable resolution.

Further, a stereo camera 105 is fixed to the housing frame 103. The stereo camera 105 comprises a first referencing camera 106 and a second referencing camera 108 arranged parallel to and at a distance 107 from the first referencing camera 106. The first referencing camera 106 and the second referencing camera 108 are each configured as digital infrared-sensitive black-and-white cameras, which thus merely record an intensity value for each image point. An infrared light source 109 or 110, which can be actuated in a pulsed manner, is assigned to each referencing camera 106, 108. The image input plane for the referencing cameras 106 and 108 is identical. However, the image input plane for the referencing cameras 106, 108 is positioned in front of an image input plane of the inspection camera 104. These relationships can be seen in the perspective view of FIG. 1a.

The inspection camera 104 is arranged between the first referencing camera 106 and the second referencing camera 108 on a central connecting line 110 between the referencing cameras 106, 108, in such a way that the optical axes of the referencing cameras 106, 108 are orientated parallel to the optical axis of the stereo camera 105.

A light source 111 for illumination with visible light is further arranged on the housing frame 103. The visible light source 111 is operable synchronously with the inspection camera 104 in the manner of a flash via a control system (not shown) of the inspection camera 104.

An image processing unit, for carrying out an image comparison of a first reference image taken using the first referencing camera 106 and a second reference image taken in parallel using the second referencing camera 108, is further fixed in the housing frame 103. Further, a storage unit, for storing a temporal sequence of inspection photos of the inspection camera 104 as well as a temporal sequence of location data of the inspection camera 104 and orientation data of the inspection camera 104, is provided on the housing frame 103. The storage unit and the image processing unit cannot be seen in FIG. 1a. In the context of the invention, they may in particular be provided in a separate portable unit, which may for example be in the form of a backpack.

The inspection camera unit 101 further comprises an acceleration sensor 12 fastened to the housing frame 103 and an inclination sensor 103 likewise fastened to the housing frame 103. The acceleration sensor 112 is for example formed on the basis of a piezoelectric sensor. The inclination sensor 113 may be configured in any manner familiar to the person skilled in the art. For example, in the context of the invention, capacitive liquid inclination sensors may be used. Finally, a laser pointer 124 is attached to the housing frame 103, and displays crosshairs on an object in the interior 121 to mark the centre point of the object region which is detected by an inspection photo 122 when an inspection photo 122 is taken.

FIG. 2 shows by way of example the concept behind the inspection camera unit 101 according to the invention for determining location data and orientation data by way of an image comparison of a first reference image 114 taken using the first referencing camera 106 and a second reference image 115 taken parallel using the second referencing camera 108. In FIG. 2, the reference images 114, 115 are shown in greyscale to illustrate the infrared light intensity associated with an image point.

In a first step, an evaluation pattern 116 is selected in the first reference image 114. The evaluation pattern 116 relates to an image region having a maximum contrast, in other words the transition from black to white. In the second step, the evaluation pattern 116 is searched for in the second reference value 115 taken parallel, in accordance with the parallel evaluation pattern 117. Subsequently, a position of the evaluation pattern 116 within the first reference image 114 is determined and the coordinates (x, y) associated with this position are displayed. Accordingly, a position of the parallel evaluation pattern 17 within the second reference image 115 is determined and displayed using the coordinates (x′, y′).

Taking into account the geometric arrangement of the first referencing camera 106 relative to the second referencing camera 108, and if appropriate taking into account data from the acceleration sensor 112 and/or the inclination sensor 113, according to the invention the image comparison when searching for the parallel evaluation pattern 117 in the second reference image 115 can be limited to a substantially line-like or rectangle-like region 118 to reduce the calculation time.

By way of the positions, characterised by the coordinates (x, y) and (x′, y′), of the evaluation pattern 116 in the first reference image 114 and the parallel evaluation pattern 117 in the second reference image 115, the location and orientation of the stereo camera 105, and also of the inspection camera 104 on the basis of the known arrangement of the inspection camera 104 relative to the stereo camera 105, are carried out by way of trigonometric calculations taking into account the distance 107 between the first referencing camera 106 and the second referencing camera 108.

FIG. 3 purely schematically shows different fastening options in the context of the invention of the inspection camera unit 101 of FIG. 1a. The left of the drawing shows that the inspection camera unit 101 can be fastened to a type of waistcoat 119 in the chest region of an inspector 120.

The central part of FIG. 3 illustrates attachment of the inspection camera unit 101 according to the invention to a work helmet 102. Finally, the right-hand part of FIG. 3 shows the attachment of the inspection camera unit 101 according to the invention to a waistcoat 119 in the neck region of the inspector 120.

FIG. 4 illustrates how registering, in other words alignment of the reference data obtained by the inspection camera unit 101 according to the invention using an external model of the interior, for example of a ship, is carried out in the context of the invention. For this purpose, an inspection photo 122 is assigned to a three-dimensional model 123 of the interior 121 once manually using the inspection camera unit 101 in the interior 121 to be inspected.

FIG. 1a-4 thus propose an inspection camera unit 101 and a method for inspecting interiors 121 which advantageously make it possible to assign the obtained inspection photos 122 to an existing three-dimensional model 123. The utility of the inspection photos 122 is thus increased considerably. For example, historical considerations by comparison of inspection photos 122 taken at different times can be carried out, since it is possible to establish which inspection photos 122 show the same region of the interior 121. To establish this, a known opening angle of the inspection camera 104 may also be taken into account, which given knowledge of the situation and orientation of the inspection camera 104 defines a viewing cone, the section plane of which with the three-dimensional model 123 of the interior 121 specifies the detected object region.

An inspection camera unit and an associated method which can be used in the interior, where access to for example satellite-assisted position determination methods is generally not possible, are thus advantageously provided. In addition, the interior does not have to be provided in advance with devices which make localisation possible.

FIG. 5 illustrates schematically the taking of a thickness measurement using a sensor unit 125 according to the invention for ultrasound thickness measurement. The sensor unit 125 comprises an ultrasound thickness measurement sensor 126, a sensor operation unit 127, a sensor data store 128 and a situation indicator 129. In the embodiment illustrated in FIG. 5, the sensor operation unit 127 and the sensor data store 128 are connected via a cable to the unit consisting of the sensor head 126 and the situation indicator 129. This provides the option of arranging the sensor operation unit 127 and the sensor data store 128 for example in a backpack which an operator wears on his back, so as to make the unit containing the actual sensor head 126 light and thus easy to handle.

The situation indicator 129 is arranged in the extension of the sensor head 126 adjacent thereto on the sensor head axis 130. The situation indicator 129 comprises two LEDs 131, 132 arranged spaced apart along the sensor head axis 130. The LEDs 131, 132 are connected to the sensor operation unit 127 in such a way that when the storage of a measurement signal from the sensor head 126 in the sensor data store 128 is triggered the LEDs 131, 132 are briefly switched on. In the embodiment illustrated in FIG. 5, the LEDs emit infrared light.

When used as intended, the sensor unit 125 illustrated in FIG. 5 cooperates with an infrared-sensitive stereo camera 105 as part of an inspection camera unit 101, for example in accordance with FIG. 1a, as follows.

When the storage of a measurement signal from the sensor head 126 for the ultrasound thickness measurement of an object to be measured, such as a steel plate 133, is triggered via the sensor operation unit 127, the LEDs 131, 132 are briefly switched on. The LEDs 131, 132 subsequently emit infrared light 134.

The referencing cameras 106, 107 of the stereo camera 105, as part of an inspection camera 101, subsequently each capture the sensor unit 125. As a result of the emitted infrared light 124, the portions of the situation indicator 129 comprising the LEDs 131, 132 have an increased contrast. As a result of the increased contrast, it is possible for the stereo camera 105, by the method described above, to record the location and situation of the sensor head 126 of the sensor unit 125 at the time when the storage of a measurement signal in the sensor data store 128 is triggered. A prerequisite is that when the storage of a measurement signal is triggered the sensor unit 125 and in particular the situation indicator 129 is located in the field of vision of both referencing cameras 106, 107.

Advantageously, using the sensor unit 125 configured according to the invention it is also possible to record the location and situation of the sensor head 126 at the time when a measurement signal is stored. This makes it possible, for example in the case of an ultrasound thickness measurement of the steel plate 133, to assign an exact situation and direction to the thickness measurement. In this context, the location and situation are recorded relative to the location and situation of the stereo camera 105. The location and situation of the stereo camera 105 can be assigned to an external coordinate system, such as a ship coordinate system, by referencing using the above-described method.

### LIST OF REFERENCE NUMERALS

101 inspection camera unit
102 work helmet
103 housing frame
104 inspection camera
105 stereo camera
106 first referencing camera
107 distance
108 second referencing camera
109 infrared light source
110 central connecting line
111 light source
112 acceleration sensor
113 inclination sensor
114 first reference image
115 second reference image
116 evaluation pattern
117 parallel evaluation pattern
118 rectangle-like sub-region
119 waistcoat
120 inspector
121 interior
122 inspection photo
123 three-dimensional model
124 laser pointer
125 sensor unit
126 sensor head
127 sensor operation unit
128 sensor data store
129 situation indicator
130 sensor head axis
131 LED
132 LED
133 steel plate
134 IR light

1. An inspection camera unit, comprising:
an inspection camera that takes an inspection photo;
a stereo camera that comprises a first referencing camera and a second referencing camera and obtains relative location data and orientation data of the inspection camera; and
wherein the relative location data and orientation data are assigned to the inspection photo.

2. (canceled)

3. An inspection camera unit according to claim 1, wherein at least one of the first referencing camera and the second referencing camera is a black-and-white camera.

4. An inspection camera unit according to claim 1, wherein the stereo camera is infrared-sensitive, and comprises an infrared source being capable of pulsed operation.

5. An inspection camera unit according to claim 1, wherein the stereo camera comprises an image processing unit that performs an image comparison of a first reference image taken by the first referencing camera with a second reference image taken by the second referencing camera.

6. An inspection camera unit according to claim 5, wherein the image comparison comprises selecting an evaluation pattern in the first reference image, locating the evaluation pattern in the second reference image, and determining a position of the evaluation pattern within the first reference image and a position of the evaluation pattern within the second reference image.

7. An inspection camera unit according to claim 6, wherein the evaluation pattern comprises an image region having a maximum contrast.

8. An inspection camera unit according to claim 1, further comprising at least one of an acceleration sensor and an inclination sensor.

9. An inspection camera unit according to claim 1, wherein the inspection camera unit evaluates data relating to an opening angle of the inspection camera.

10. An inspection camera unit according to claim 1, wherein one of the first referencing camera and the second referencing camera is used in place of the inspection camera.

11. An inspection camera unit according to claim 1, further comprising:
a laser light source that emits light onto an object region which is currently detectable from an inspection photo on a basis of location and orientation of the inspection camera.

12. An inspection camera unit according to claim 5, wherein the image comparison is based on sub-regions of the first and second reference images.

13. An inspection camera unit according to claim 1, further comprising:
a storage unit that stores a temporal sequence of inspection photos and a temporal sequence of relative location data and orientation data of the inspection camera.

14. An inspection camera unit according to claim 1, wherein the inspection camera is arranged between the first referencing camera and the second referencing camera.

15. A method for inspecting an interior, comprising:
taking an inspection photo using an inspection camera unit that includes an inspection camera; and
referencing the inspection photo by:
obtaining relative location data and orientation data of the inspection camera during capture of the inspection photo; and
assigning the relative location data and the orientation data to the inspection photo, the relative location data and the orientation data being classified into a coordinate system of the interior.

16. A method according to claim 15, further comprising:
measuring a structure in the interior using the inspection photo, the step of measuring a structure comprising:
selecting an inspection photo image point in the inspection photo;
determining reference image points corresponding to the selected inspection photo image point in a first reference image and in a second reference image; and
calculating a Euclidean distance between the reference image points.

17. A sensor unit comprising:
sensor that measures at least one property of an interior;
an inspection camera unit; and
situation indicator that cooperates with the inspection camera unit to determine a situation of the sensor characterized by relative location and orientation.

18. A sensor unit according to claim 17, wherein the situation indicator comprises regions which are arranged spaced apart on a sensor axis and which bring about an optical contrast.

19. A sensor unit according to claim 17, wherein the situation indicator is able to be switched on.

20. A sensor unit according to claim 17, wherein the situation indicator comprises at least one point-like light source.

21. A measurement arrangement, comprising:
at least one sensor system for generating measurement data;
a first unreferenced situation detection system for generating at least one of first position and orientation data;
a second unreferenced situation detection system for generating at least one of second position and orientation data;
at least one storage device that stores the measurement data and position and orientation information coded by at least one of the first and second position and orientation data; and
wherein the first and second position and orientation data are referenced to one another.

22. A measurement arrangement according to claim 21, further comprising:
a computation device that combines the first and second position and orientation data into resultant position and orientation data.

23. A measurement arrangement according to claim 21, wherein the first unreferenced situation detection system comprises an optical situation detection system and the second unreferenced situation detection system comprises an inertial situation detection system.

24. A measurement arrangement according to claim 23, wherein the optical situation detection system comprises a stereo camera system.

25. A measurement arrangement according to claim 24, further comprising a calibration device for calibrating at least one camera of the stereo camera system.

26. A measurement arrangement according to claim 21, wherein the at least one sensor system comprises an unreferenced situation detection system.

27. A measurement arrangement according to claim 21, further comprising:
an additional situation detection system that comprises at least one of a global navigation satellite system (GNSS) sensor, a laser scanner, a magnetometer and an inclination sensor.

28. A system, comprising:
a sensor system that generates measurement data;
a first unreferenced situation detection system that generates at least one of first position and orientation data;
a second unreferenced situation detection system that generates at least one of second position and orientation data; and
wherein the measurement data and position and orientation information coded by at least one of the first and second position and orientation data are referenced to one another and stored in a storage.

29. A system according to claim 28, wherein the first and the second position and orientation data are combined into resultant position and orientation data.

30. A system according to claim 28, wherein an origin of a system-internal coordinate system of the first unreferenced situation detection system and an origin of a system-internal coordinate system of the second unreferenced situation detection system and an origin of a shared coordinate system are initialized at a beginning of an operation of the system or at a beginning of a measurement or at a time of generation of an initialization signal.
